(19) United States
(12) Patent Application Publication
(10) Pub. No.: US 2009/0133235 A1
(43) Pub. Date: May 28, 2009

(54) Buckle device

(76) Inventor: Vincent Chang, Changhua (TW)

Correspondence Address: CHARLES E. BAXLEY, ESQUIRE, 90 JOHN STREET, SUITE 309, NEW YORK, NY, 10038, US

(21) Appl. No.: 11/986,723

(22) Filed: Nov. 26, 2007

(51) Int. Cl. B25B 25/00

(52) U.S. Cl. 24/68 CD

(57) ABSTRACT

A buckle device includes a base coupled to a strap, an operating arm rotatably secured to the base with a stationary axle, a shaft attached to the operating arm, a latch slidably attached to the operating arm to selectively lock the operating arm to the base, and another strap engaged around the stationary axle to form two strap segments, the shaft may force the strap segment to tighten the straps, the base includes one or more fasten notches for engaging with the latch for retaining the latch and the operating arm to the base at a fastening position when the straps may further be pulled away from each other, and includes one or more lock notches for solidly locking the latch.

### BACKGROUND OF THE INVENTION

1. Field of the Invention

The present invention relates to a buckle device, and more particularly to a simplified buckle device for coupling or suspending straps and for anchoring and positioning the straps to the buckle device and for preventing the buckle device from becoming loosened from or relative to the buckle device.

2. Description of the Prior Art

Typical connector devices or buckle devices for coupling or for suspending straps have been developed for coupling two straps together, and comprises a ring or loop for attaching or coupling to a lock device, and the straps are coupled to the loop and the lock device respectively, for allowing the straps to be coupled together by engaging the loop toward the lock device.

For example, U.S. Pat. No. 7,020,933 to Chang, the present applicant, discloses one of the typical buckle devices comprising a strap ring coupled to one of the straps, and a connector frame couple to the other strap, and the strap ring may be attached to the connector frame, and may be selectively locked to the connector frame with a swinging member.

However, the straps may be coupled and secured to the buckle device with the swinging member, and may not be further fastened or tensioned to the buckle device; i.e. the swinging member should be unfastened or released from the connector frame before the straps may be further fastened or tensioned to the buckle device, such that the typical buckle device may not be easily operated by the users or operators.

The present invention has arisen to mitigate and/or obviate the afore-described disadvantages of the conventional connector or buckle devices.

### SUMMARY OF THE INVENTION

The primary objective of the present invention is to provide a buckle device for allowing two straps to be easily and quickly tightened together and for firmly anchoring and positioning the straps to the buckle device and for allowing the straps to be further fastened or tensioned to the buckle device.

In accordance with one aspect of the invention, there is provided a buckle device comprising a base including a chamber formed therein and defined between two side panels and a bottom panel, and including a first end and a second end, and including at least one anchor notch and at least one fasten notch formed therein and located closer to the first end and the second end of the base respectively, a stationary axle straddled between the side panels of the base and spaced from the bottom panel, and located between the first end and the second end of the base, a first strap attached to the first end of the base, an operating arm rotatably attached to the base with the stationary axle, a shaft attached to the operating arm and movable in concert with the operating arm and rotatable around the stationary axle, a latch slidably attached to the operating arm and engageable with either the fasten notch or the anchor notch of the base to selectively lock the operating arm to the base either at a fastening position or an anchoring position, and a second strap including an intermediate portion engaged around the stationary axle to form a first strap segment and a second strap segment, the shaft being movable and engageable with the intermediate portion of the second strap to force the second strap segment onto the first strap segment and to tighten the second strap to the base and the operating arm when the operating arm is moved toward the base and locked to the base at the fastening position with the latch, and the shaft releasing the intermediate portion of the second strap when the operating arm is rotated away from the base and when the latch is engaged with the anchor notch of the base at the anchoring position, when in the fastening position, the shaft is located between the stationary axle and the second end of the base, and the shaft being located closer to the second end of the base than the stationary axle to allow the first strap segment to be forced onto the second strap segment when the first strap and the second strap are forced away from each other, and to allow the second strap segment to be further pulled by a user, and to further tighten the first strap and the second strap, and when in the anchoring position, the stationary axle is located between the shaft and the second end of the base to allow the second strap to be pulled away from the first strap.

The base includes at least one lock notch formed therein and located closer to the second end of the base than the fasten notch of the base for selectively engaging with the latch and for retaining the latch and the operating arm to the base at a locking position when the operating arm is further rotated toward the base from the fastening position.

The base includes at least one release notch formed therein and located closer to the first end of the base then the anchor notch of the base for selectively engaging with the latch and for retaining the latch and the operating arm to the base at a release position when the operating arm is further rotated relative to the base from the anchoring position.

The operating arm includes an opening formed therein, and the latch includes at least one hand grip extended outwardly through the opening of the operating arm, to allow the latch to be moved relative to the operating arm with the hand grip.

The operating arm includes an ear having an aperture formed therein, and the latch includes an extension extended therefrom and slidably engaged through the aperture of the ear of the operating arm to guide the latch to slide relative to the operating arm.

The operating arm includes two side plates each having a groove formed therein, and the latch includes two side catches slidably engaged through the grooves of the side plates of the operating arm, to guide the latch to slide relative to the operating arm.

The base includes two passages formed in the bottom panel to form a first end bar and a second end bar and an intermediate bar. The base includes at least one projection extended therefrom, and the operating arm includes a cam portion for engaging with the projection and for limiting the operating arm to rotate relative to the base.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a buckle device in accordance with the present invention;

FIG. 2 is a perspective view of the buckle device;

FIG. 3 is a cross sectional view taken along lines 3-3 of FIG. 2;

FIG. 4 is a cross sectional view similar to FIG. 3, having two straps attached to the buckle device;

FIGS. 5, 6 are cross sectional views similar to FIG. 4, illustrating the operation of the buckle device;

FIG. 7 is an exploded view illustrating the other arrangement of the buckle device;

FIG. 8 is a perspective view of the buckle device as shown in FIG. 7; and

FIGS. 9, 10, 11 are cross sectional views illustrating the operation of the buckle device as shown in FIGS. 7 and 8.

### DETAILED DESCRIPTION OF THE PREFERRED EMBODIMENT

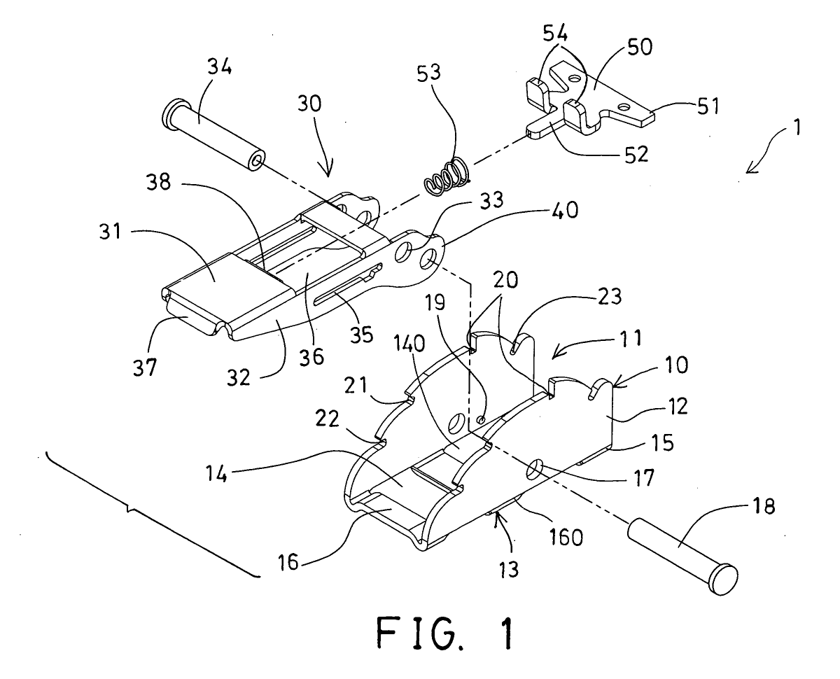

Referring to the drawings, and initially to FIGS. 1-4, a buckle device 1 in accordance with the present invention comprises a base 10 including a chamber 11 formed therein and defined between two side panels 12 and a bottom panel 13, and including two passages 14, 140 formed in the bottom panel 13 thereof for forming or defining two or three bars 15, 16, 160 such as a first or front bar or end 15 and a second or rear bar or end 16, and an intermediate bar 160. Each of the side panels 12 includes an orifice 17 formed therein (FIG. 1) and aligned with each other, to receive a stationary axle 18 therein, and to allow the stationary axle 18 to be supported and straddled between the side panels 12 and to be spaced from the bottom panel 13 and located between the bars or ends 15, 16 of the base 10. The base 10 further includes one or more, such as two projections 19 extended inwardly from the side panels 12 respectively.

The base 10 further includes one or more, such as two anchor notches 20 formed therein, such as formed in the middle or upper portions of the side panels 12 thereof respectively, and includes one or more, such as two fasten notches 21 formed therein, such as formed in the upper portions of the side panels 12 thereof and located between the stationary axle 18 and the rear end bar 16 of the base 10 respectively, and includes one or more, such as two lock notches 22 formed therein, such as formed in the upper portions of the side panels 12 thereof and located between the fasten notches 21 and the rear end bar 16 of the base 10 respectively, and includes one or more, such as two release notches 23 formed therein, such as formed in the upper portions of the side panels 12 thereof and located in front of the anchor notches 20 and closer to the front end bar 15 of the base 10 respectively. It is preferable that the stationary axle 18 is located between the anchor notches 20 and the fasten notches 21 of the base 10.

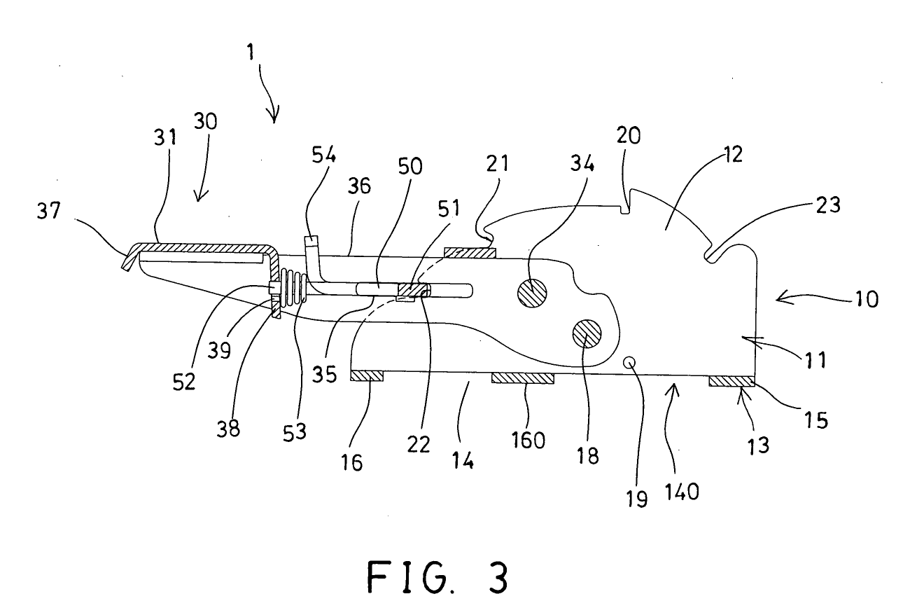

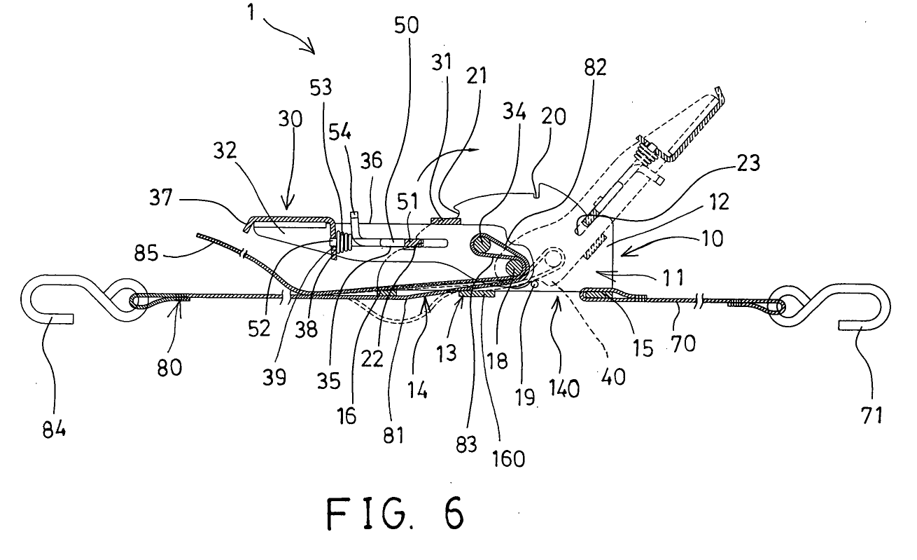

An operating arm 30 is engaged onto the base 10 or received in the chamber 11 of the base 10, and is rotatably secured to the base 10 with the stationary axle 18, and includes an upper plate 31, and two side plates 32 extended downwardly from and perpendicular to the upper plate 31. The operating arm 30 includes two holes 33 formed in the side plates 32 respectively (FIG. 1) to receive or to attach or to secure a shaft 34 to the operating arm 30, such that the shaft 34 may be moved or rotated in concert with the operating arm 30 and rotatable around the stationary axle 18. The operating arm 30 further includes two grooves 35 formed in the side plates 32 respectively, and includes an opening 36 formed in the middle portion of the upper plate 31, and includes a handle 37 and an ear 38 extended from the upper plate 31, in which the ear 38 includes an aperture 39 formed therein (FIGS. 3-6), and includes a cam portion 40 for engaging with the projections 19 (FIG. 6).

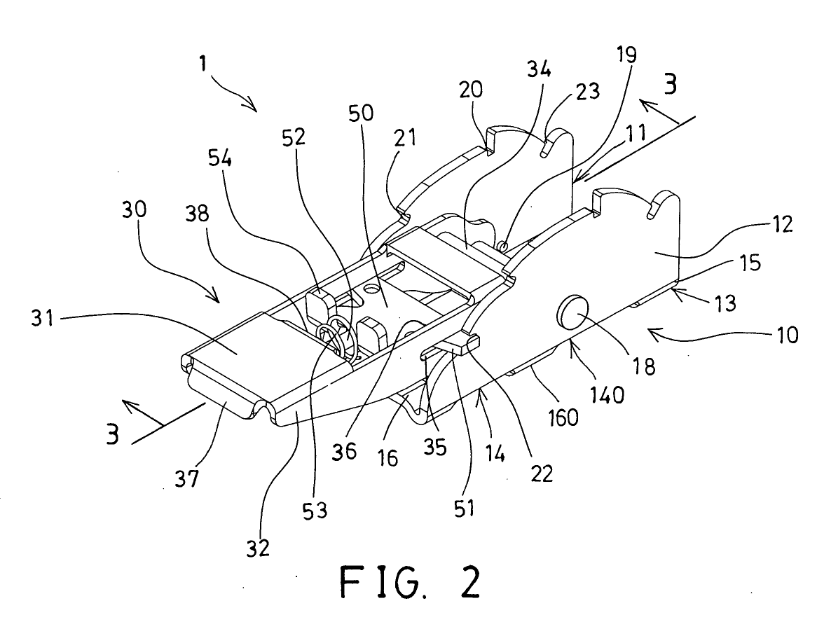

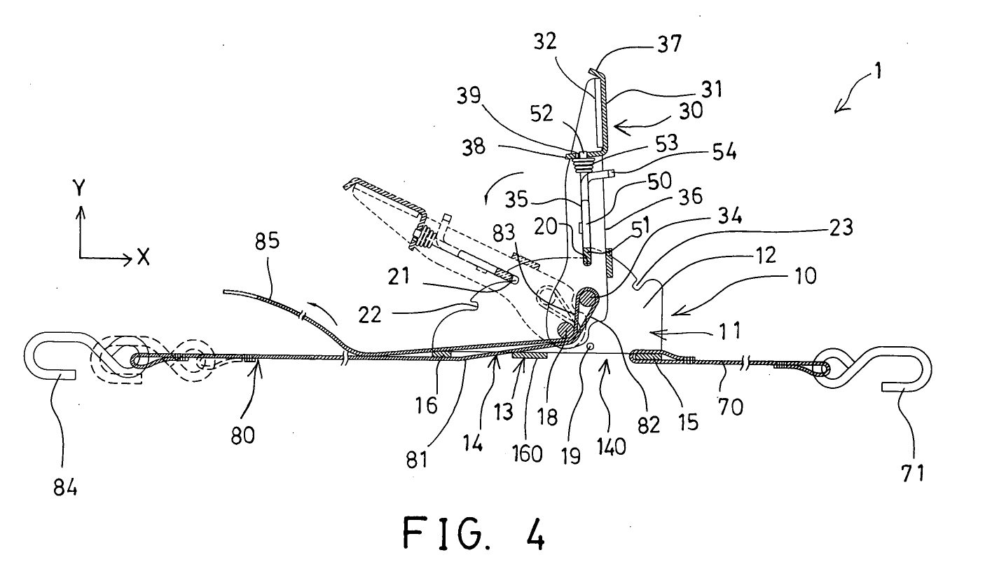

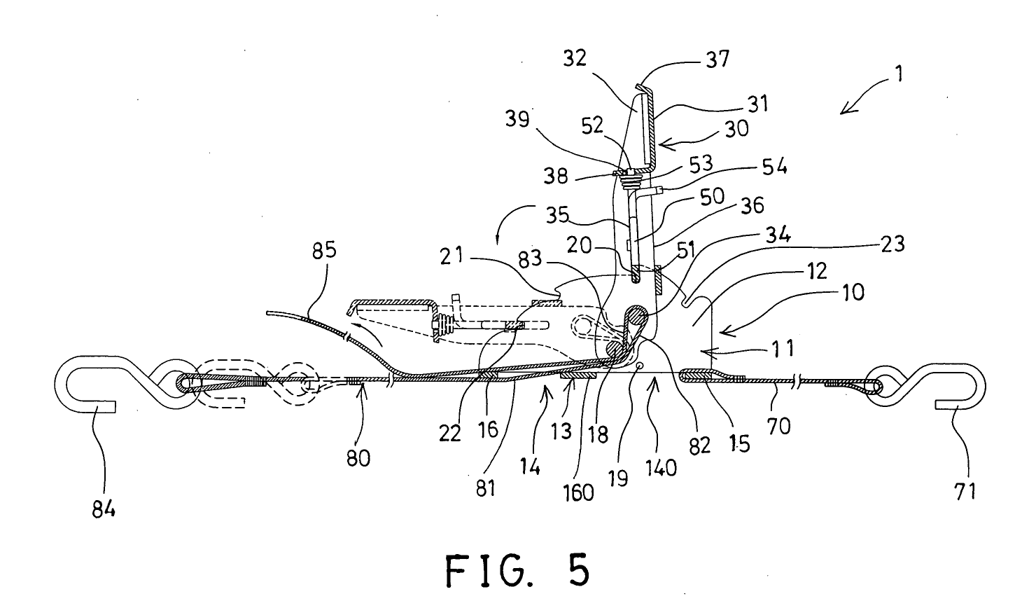

A latch 50 includes two side catches 51 extended therefrom and slidably received in the grooves 35 of the operating arm 30 respectively, to guide and to limit the latch 50 to slide relative to the operating arm 30. The latch 50 may further include an extension 52 extended therefrom and slidably received through the aperture 39 of the ear 38 of the operating arm 30, to further stably guide the latch 50 to slide relative to the operating arm 30. A spring 53 is engaged onto the extension 52 and engaged between the operating arm 30 and the latch 50 to bias the latch 50 away from the ear 38, or to bias the catches 51 to engage into either the anchor notches 20 (FIGS. 4, 5), the fasten notches 21 (as shown in dotted lines in FIG. 4), the lock notches 22 (FIGS. 2, 3, 6 and as shown in dotted lines in FIG. 5), or the release notches 23 (as shown in dotted lines in FIG. 6) of the base 10 respectively, and thus to anchor or lock the operating arm 30 to the base 10 at an anchoring position, a fastening position, a locking position, or a release position respectively.

The latch 50 includes one or more hand grips 54 extended therefrom, and extended outwardly through the opening 36 of the operating arm 30, for allowing the latch 50 to be easily moved relative to the operating arm 30, against the spring 53, by the users. As shown in FIGS. 4-6, a strap 70 may be coupled or secured to one of the bars or the first or front end bar 15 of the base 10, and may be coupled to a hook 71 or the like. Another strap 80 may have an intermediate portion 81 engaged through the passage 14 of the base 10, and engaged around the stationary axle 18 for forming two overlapped strap segments 82, 83, such as an outer or first strap segment 82 and an inner or second strap segment 83, and to have the other or second end bar 16 of the base 10 to be disposed between the strap segments 82, 83, in which the outer strap segment 82 has an outer end coupled to another hook 84 or the like, and has an inner end 85 pullable by the users.

In operation, as shown in FIG. 4, when the catches 51 of the latch 50 are pulled or released or disengaged from the fasten notches 21 of the base 10, the operating arm 30 may be rotated away from the base 10 to the anchoring position as shown in solid lines in FIG. 4 where the operating arm 30 is substantially perpendicular to the base 10, and the stationary axle 18 is located between the shaft 34 and the second end bar 16 of the base 10, and the shaft 34 may also be rotated or moved away from the intermediate portion 81 of the strap 80 to release the strap 80, and such that the strap 80 may be pulled or tightened relative to the base 10 or relative to the other strap 70 at this moment, by such as pulling either of the strap segments 82, 83 or the inner end 85 of the strap 80. After the straps 70, 80 or the hooks 71, 84 have been tightened or forced or pulled toward each other by pulling the inner strap segment 83 of the strap 80, the operating arm 30 may then be forced toward the base 10, and may actuate or force the shaft 34 to engage with and to tighten the intermediate portion 81 of the strap 80.

For example, the operating arm 30 may then be locked to the base 10 at the fastening position by the latch 50 which is engaged with the fasten notches 21 of the base 10 (as shown in dotted lines in FIG. 4). It is to be noted that, when the operating arm 30 is rotated away from or is released from the base 10 to the anchoring position as shown in solid lines in FIGS. 4 and 5, the strap 80 may be easily and quickly pulled and tightened by pulling the inner strap segment 83 or the inner end 85 of the strap 80, and then the operating arm 30 may be forced toward the base 10 to actuate the shaft 34 to engage with the strap segments 82, 83 of the strap 80, and particularly to force the inner or second strap segment 83 to or against the outer or first strap segment 82, and thus to tighten the intermediate portion 81 of the strap 80. The straps 70, 80 may thus be easily and quickly tightened and locked together by the relative movement between the base 10 and the operating arm 30 and by the latch 50.

As shown in dotted lines in FIG. 4, when in the fastening position, the latch 50 may be biased or forced to engage with the fasten notches 21 of the base 10 by the operating arm 30, and the shaft 34 is moved or rotated to an intermediate position between the second end bar 16 and the stationary axle 18 of the base 10, or the stationary axle 18 is located closer to the first end bar 15 of the base 10 than the shaft 34, or the shaft 34 is located closer to the second end bar 16 of the base 10 than the stationary axle 18, and the stationary axle 18 and the shaft 34 are spaced from each other for a selected distance therebetween at or along both the lateral direction or axis X and the vertical direction or axis Y (FIG. 4) for allowing the strap segments 82, 83 or the intermediate portion 81 of the strap 80 to be suitably tightened by the shaft 34 and the stationary axle 18.

In this arrangement, as also shown in dotted lines in FIG. 4, when the straps 70, 80 or the hooks 71, 84 are tightened onto the cargo or other objects and when the straps 70, 80 or the hooks 71, 84 are forced or moved away from each other, the outer or first strap segment 82 may be forced toward or onto or against the inner or second strap segment 83 such that the strap segments 82, 83 of the strap 80 will not be unfastened or released from each other. It is further to be noted that the latch 50 may be biased or forced to engage with the fasten notches 21 of the base 10 when the buckle device 1 is not required to be solidly or tightly secured onto the cargo or other objects.

At this moment, the inner end 85 or the second strap segment 83 of the strap 80 may be further pulled away from the operating arm 30 and the base 10 of the buckle device 1 by the users to allow the straps 70, 80 or the hooks 71, 84 to be further tightened by the users. The circular cross section of the stationary axle 18 and the shaft 34 allows the inner end 85 or second strap segment 83 of the strap 80 to be further pulled by the users or may facilitating the pulling of the inner end 85 or second strap segment 83 of the strap 80 by the users. When it is required to solidly or tightly secure the buckle device 1 onto the cargo or other objects, as shown in solid lines in FIGS. 3 and 6, and as also shown in dotted lines in FIG. 5, the latch 50 may be selectively moved and biased or forced to engage with the lock notches 22 of the base 10 at the locking position when required. At this moment, the strap 80 may no longer be further pulled by the users. The projections 19 of the base 10 may be engaged with the cam portion 40 of the operating arm 30 for limiting the operating arm 30 to rotate relative to the base 10.

When it is required to completely release the straps 70, 80, as shown in dotted lines in FIG. 6, the latch 50 may be selectively moved and biased or forced to engage with the release notches 23 of the base 10 at the release position. At this moment, the strap 80 may be completely released or may be loosened and may be easily pulled or moved relative to the operating arm 30, the base 10, the stationary axle 18 and the shaft 34, and the hooks 71, 84 may be easily and quickly attached onto or released or disengaged from the cargo or other objects.

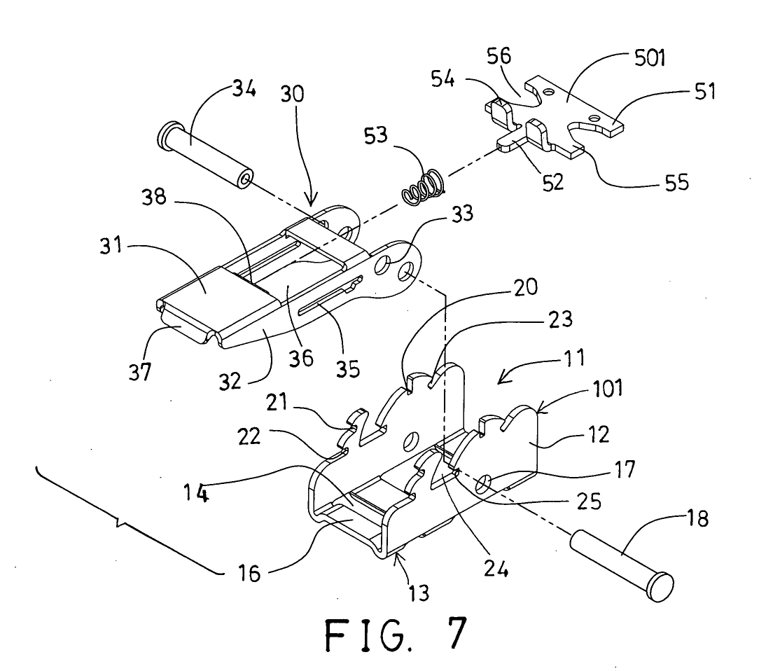

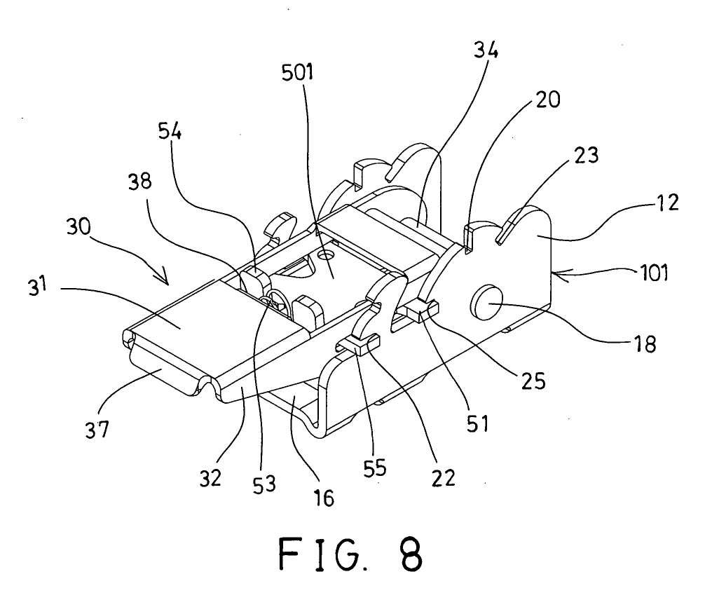

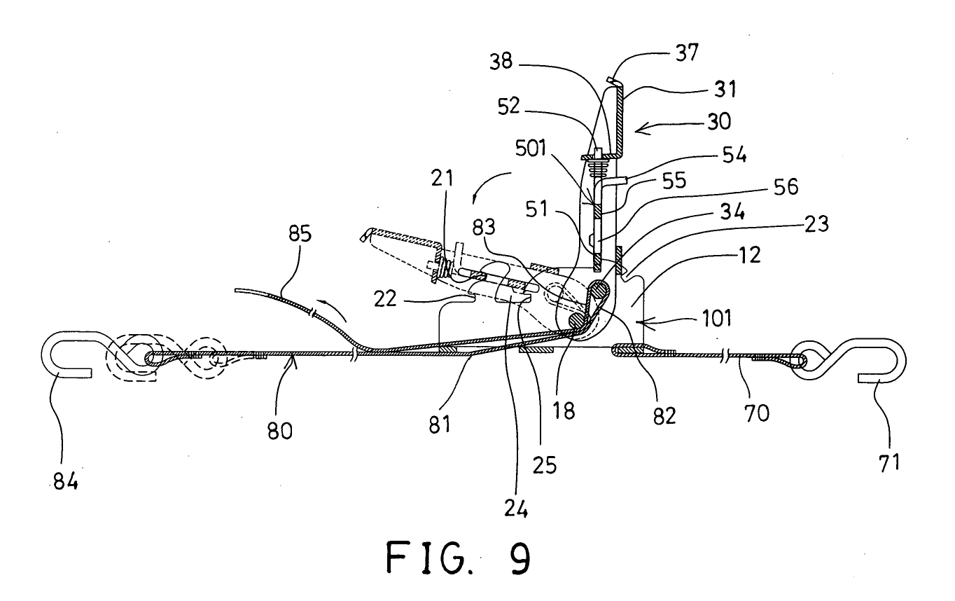

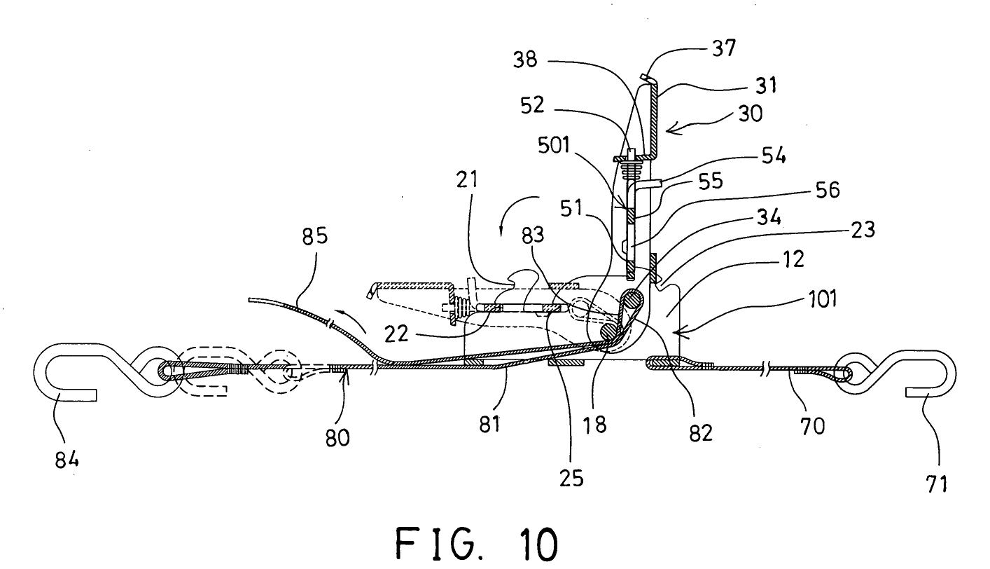

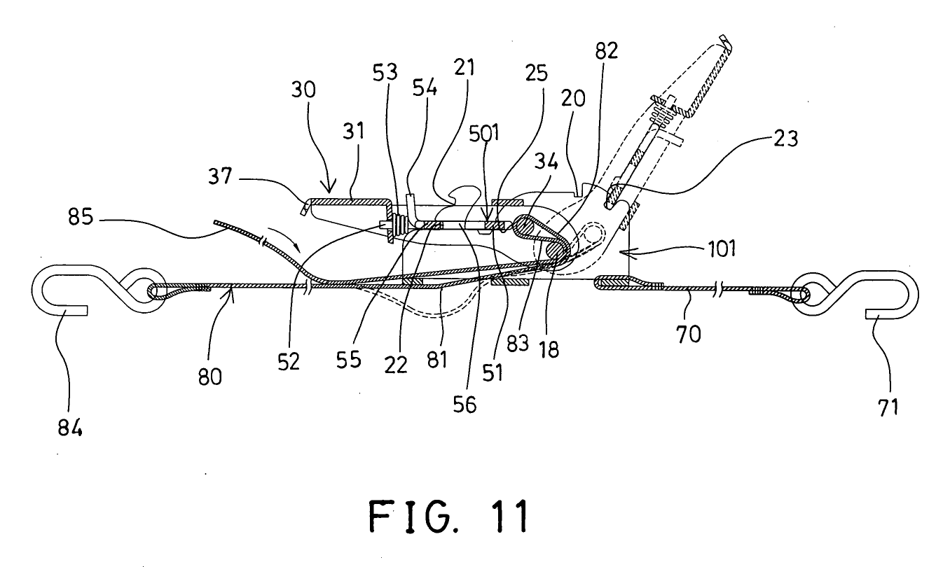

Alternatively, as shown in FIGS. 7-11, the base 101 may, optionally, further include a recess 24 formed therein, such as formed in the middle or upper portions of the side panels 12 thereof respectively, and formed or located between the anchor notches 20 and the fasten notches 21 of the base 10, and may further include one or more, such as two additional lock notches 25 formed therein, such as formed in the upper portions of the side panels 12 thereof and communicating with the recess 24 of the base 10 respectively, and the latch 501 may further include two additional catches 55 extended therefrom and parallel to the catches 51 to form two spaces 56 between the catches 51, 55 for engaging with the lock notches 25, 22 of the base 10 at the locking position and for further solidly securing or locking the latch 50 and the operating arm 30 to the base 10.

Accordingly, the buckle device in accordance with the present invention may be used for allowing two straps to be easily and quickly tightened together and for firmly anchoring and positioning the straps to the buckle device and for allowing the straps to be further fastened or tensioned to the buckle device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A buckle device comprising:
a base including a chamber formed therein and defined between two side panels and a bottom panel, and including a first end and a second end, and including at least one anchor notch and at least one fasten notch formed therein and located closer to said first end and said second end of said base respectively,
a stationary axle straddled between said side panels of said base and spaced from said bottom panel, and located between said first end and said second end of said base,
a first strap attached to said first end of said base,
an operating arm rotatably attached to said base with said stationary axle,
a shaft attached to said operating arm and movable in concert with said operating arm and rotatable around said stationary axle,
a latch slidably attached to said operating arm and engageable with either said at least one fasten notch or said at least one anchor notch of said base to selectively lock said operating arm to said base either at a fastening position or an anchoring position, and
a second strap including an intermediate portion engaged around said stationary axle to form a first strap segment and a second strap segment, said shaft being movable and engageable with said intermediate portion of said second strap to force said second strap segment onto said first strap segment and to tighten said second strap to said base and said operating arm when said operating arm is moved toward said base and locked to said base at the fastening position with said latch, and said shaft releasing said intermediate portion of said second strap when said operating arm is rotated away from said base and when said latch is engaged with said at least one anchor notch of said base at the anchoring position,
when in the fastening position, said shaft being located between said stationary axle and said second end of said base, and said shaft being located closer to said second end of said base than said stationary axle to allow said first strap segment to be forced onto said second strap segment when said first strap and said second strap are forced away from each other, and to allow said second strap segment to be further pulled by a user, and to further tighten said first strap and said second strap, and
when in the anchoring position, said stationary axle being located between said shaft and said second end of said base to allow said second strap to be pulled away from said first strap.

2. The buckle device as claimed in claim 1, wherein said base includes at least one lock notch formed therein and located closer to said second end of said base than said at least one fasten notch of said base for selectively engaging with said latch and for retaining said latch and said operating arm to said base at a locking position when said operating arm is further rotated toward said base from the fastening position.

3. The buckle device as claimed in claim 1, wherein said base includes at least one release notch formed therein and located closer to said first end of said base then said at least one anchor notch of said base for selectively engaging with said latch and for retaining said latch and said operating arm to said base at a release position when said operating arm is further rotated relative to said base from the anchoring position.

4. The buckle device as claimed in claim 1, wherein said operating arm includes an opening formed therein, and said latch includes at least one hand grip extended outwardly through said opening of said operating arm, to allow said latch to be moved relative to said operating arm with said at least one hand grip.

5. The buckle device as claimed in claim 1, wherein said operating arm includes an ear having an aperture formed therein, and said latch includes an extension extended therefrom and slidably engaged through said aperture of said ear of said operating arm to guide said latch to slide relative to said operating arm.

6. The buckle device as claimed in claim 1, wherein said operating arm includes two side plates each having a groove formed therein, and said latch includes two side catches slidably engaged through said grooves of said side plates of said operating arm, to guide said latch to slide relative to said operating arm.

7. The buckle device as claimed in claim 1, wherein said base includes two passages formed in said bottom panel to form a first end bar and a second end bar and an intermediate bar.

8. The buckle device as claimed in claim 1, wherein said base includes at least one projection extended therefrom, and said operating arm includes a cam portion for engaging with said at least one projection and for limiting said operating arm to rotate relative to said base.
